(19) United States
(12) Patent Application Publication
(10) Pub. No.: US 2006/0135180 A1
(43) Pub. Date: Jun. 22, 2006

(54) Method, system, and program product for providing services and information to wireless mobile devices

(75) Inventors: Donald Paul Jakel, Rochester, MN (US); Eric John Nelson, Rochester, MN (US); Steven Thomas Will, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/016,205

(22) Filed: Dec. 17, 2004

(51) Int. Cl. H04Q 7/20

(52) U.S. Cl. 455/456.5; 455/456.1

(57) ABSTRACT

A method, system and computer program product of determining the location of one or more cell reception areas having predefined signal characteristics relative to a current location of the wireless mobile device; and, dynamically determining directions from the wireless mobile device at the current location to selected ones of the one or more cell reception areas having at least predefined signal characteristics. In addition, further included is the providing the directions from the wireless mobile device at the current location to the one or more cell reception areas having predefined signal characteristics.

### BACKGROUND OF THE INVENTION

This invention relates generally to improved methods, systems, and computer program products for dynamically providing information to mobile wireless communication devices based on several sources of input including signal strength and geographic locations of cell coverage areas.

Users are interested in wireless mobile device coverage areas because they desire knowledge of good reception areas of a provider in order to avoid paying additional ‘roaming’ charges. Furthermore, users desire such knowledge in order to avoid calls being “dropped” or otherwise being without reception. Accordingly, wireless mobile device carriers and/or wireless mobile device plans are often selected, in part, on the geographic coverage provided.

Users may research a carriers' coverage area in a number of ways. Most carriers provide coverage maps on their web sites and in stores where their products are sold. Often these maps show only very general coverage for entire regions. Moreover, these maps usually carry the disclaimer that they are provided for informational purposes only and that actual coverage may vary. Since coverage is frequently changing, specific and/or updated information may not be available in the maps provided by carriers.

As a result, users are unable to know with a high degree of certainty good reception locations, thereby increasing the likelihood of paying more for wireless mobile device coverage when ‘roaming’ and/or being without reception. Moreover, users may desire to know the whereabouts of reception areas with adequate signal strength as they travel so they can remain connected without encountering poor reception and/or additional roaming charges. Additionally, users may desire knowledge about good reception areas for trip planning purposes.

However, there is an absence in the prior art of systems, methods and computer program products for dynamically correlating current geographic locations of wireless mobile devices to cell reception areas having predefined signal characteristics including signal strength; and, providing information including directions to wireless mobile device users of good cell reception areas. Moreover, the prior art does not include a system or method of integrating such correlations in an algorithm that defines one or more paths of travel for a user to follow while, preferably, remaining within good cell reception areas.

Without the ability for dynamically correlating current geographic locations of wireless mobile devices to cell reception areas having predefined signal characteristics including signal strength; and, providing information including directions to wireless mobile device users of good cell reception areas, the true potentials of assisting wireless mobile device users are not fully met. Furthermore, there is a need for integrating such correlations in an algorithm that defines one or more paths of travel for a user to follow while, preferably, remaining within good cell reception areas.

### SUMMARY OF THE INVENTION

This invention is related to methods, apparatus, and computer program products for providing information to a wireless mobile device regarding its location relative to the one or more cells having at least predefined signal characteristics without negative effect and that overcome many of the disadvantages of prior art.

In exemplary embodiments, the present invention includes methods, apparatus, and computer program products for determining the location of one or more cell reception areas having predefined signal characteristics relative to a current location of the wireless mobile device; and, dynamically determining directions from the wireless mobile device at the current location to the one or more cell reception areas having at least predefined signal characteristics.

In an illustrated embodiment, the current location is obtained from a location locator device.

In other exemplary embodiments, the present invention includes methods, apparatus, and computer program products for determining one or more travel routes in accordance with signal strengths of cell reception areas, the method comprising: inputting data regarding a trip destination, determining if a stay within range of predefined signal strength mode of travel is selected, and if the mode is selected then accessing signal strength information of cell reception areas to input into a travel planning algorithm for determining a travel route to the trip destination based on staying within the predefined range of signal strengths.

In other exemplary embodiments, the present invention includes methods, apparatus, and computer program products for charging fees in response to providing directions based on correlating the current wireless mobile device location to signal strengths of predefined cell reception areas.

In other exemplary embodiments, the present invention includes methods, apparatus, and computer program products for charging fees in response to planning a trip based on the location and signal strengths of cell towers or reception areas relative to a path of travel of a user of a wireless mobile device.

In other exemplary embodiments, the present invention includes methods, apparatus, and computer program products for charging fees in response to subscription of services whereby information regarding locations and signal strengths of cell reception areas are provided.

These and other features and aspects of this invention will be more fully understood from the following detailed description of the preferred embodiments, which should be read in light of the accompanying drawings. It should be understood that both the foregoing generalized description and the following detailed description are exemplary, and are not restrictive of the invention.

### BRIEF DESCRIPTION OF THE DRAWINGS

FIG. 1 illustrates a diagrammatic view of an exemplary embodiment of a communications system according to the invention.

FIG. 2 illustrates a block diagram of a wireless mobile device in accordance with an exemplary embodiment of the invention.

FIG. 3 illustrates a block diagram of an apparatus according to an exemplary embodiment of the invention.

FIG. 4 illustrates a flow chart implementing a process according to an exemplary embodiment of the invention.

FIG. 5 illustrates a flow chart implementing another process of exemplary embodiment of the invention.

FIG. 6 illustrates a diagrammatic view of predefined best path travel route relative to a plurality of geographic wireless mobile device coverage areas.

### DETAILED DESCRIPTION

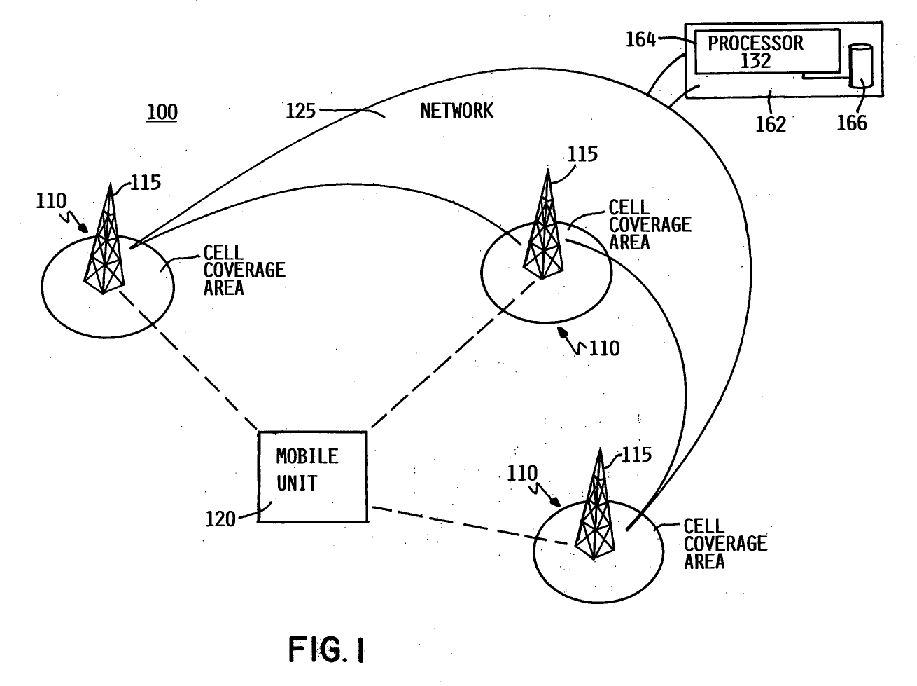

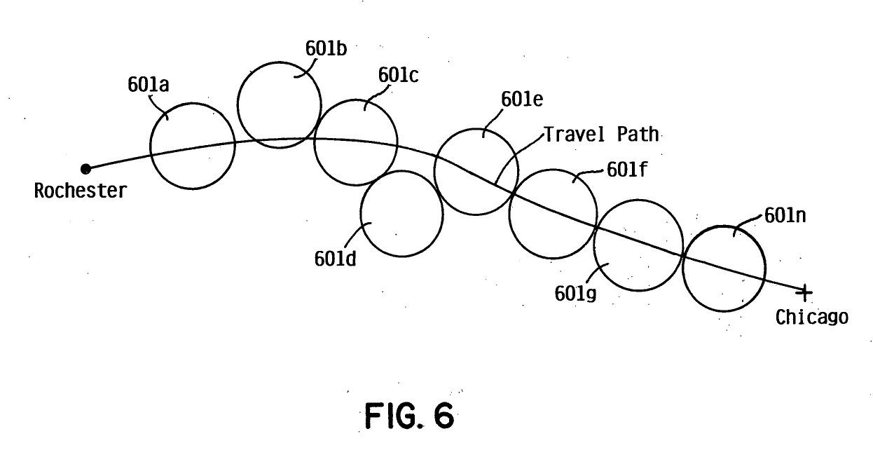

Reference is made to FIGS. 1-6 for illustrating preferred embodiments of a telecommunication system 100. The telecommunication system 100 is for providing information to wireless mobile communication devices, such as cellular phones, regarding locations of coverage areas having good reception, as well as directions to such areas.

In one exemplary embodiment, the present invention correlates the signal characteristics of coverage areas relative to the current geographic location of a wireless mobile communication device. This is carried out for providing the wireless mobile device with directional information to selected ones of the coverage areas with the predefined signal characteristics.

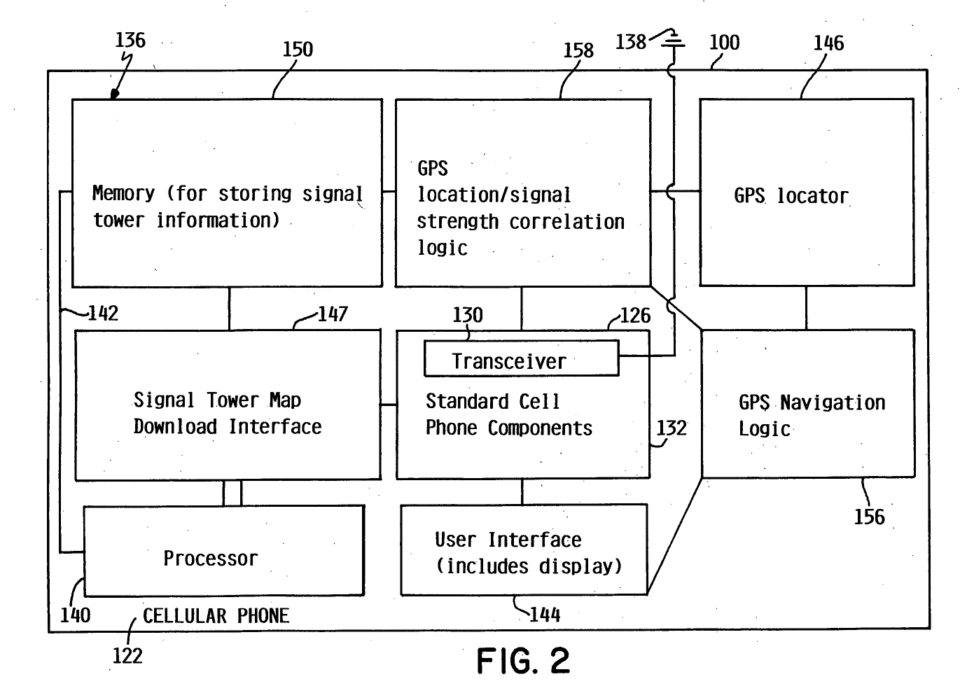

FIG. 1 illustrates an exemplary embodiment of a simple case of one of many different telecommunication systems 100 in which the present invention may be implemented. Included in the telecommunication system 100 are one or more base stations 110 that may be wireless mobile device base stations. Each of the base stations 110 may include one or more transmitting/receiving towers 115 that define the cell reception area of predefined signal characteristics that may handle a variety of suitable transmission protocols. Predefined signal characteristics include signal strengths considered sufficient for providing the desired coverage to a user of the kind of wireless mobile devices contemplated by the present invention, signals identifying the carriers of the signals in the reception areas so that one need not end up paying ‘roaming’ charges, as well as other characteristics including the kinds of transmission protocols. Clearly, the invention contemplates other signal characteristics. The base stations 110 wirelessly communicate with one or more wireless mobile devices 120. In this particular embodiment, the wireless mobile unit or client device 120 may include or be defined as a cellular phone 122 (see FIG. 2). The cellular phone device 122 provides typical functions for the operation of the wireless mobile device. The base stations 110 may, of course, be connected to a network 125 including a telephone network (telnet) or satellite communications network (satnet), or combination thereof. Besides the wireless mobile devices or units being cellular phone devices, they may also comprise pagers, personal digital assistants (PDA's), email devices, and the like. Each wireless base station 110 may communicate with fixed communication devices, such as telephone devices or computers connected by use of the Public Switched Telephone Network (PSTN), Public Switched Data Network (PSDN), Integrated Services Digital Network (ISDN), the Internet, and the like.

Referring to FIG. 2, the cellular phone device 122 may implement one of various wireless mobile device protocols and networks including analog and digital networks, and may employ one or more various standards, such as time division multiple access (TDMA), code division multiple access (CDMA), global system for mobile communication (GSM). The cellular phone device 122 may include a transceiver 130 of the kind used in conjunction with known wireless mobile device units 132. The mobile device unit 132 may include the hardware, software and combinations, which the cellular phone device to operate in the manner, intended. The transceiver 130 and the mobile device unit 132 are under the control of a computer apparatus 136. The transceiver 130 is coupled to a suitable antenna, such as an antenna 138 and is configured through hardware, software, or a combination to receive and transmit messages in the form of, for example, radio frequency (RF) signals. RF signal messages received by transceiver may be sent to the computer apparatus 136 through the mobile device unit 132. The computer apparatus 136 is configured to handle the information received and control it in a manner to be described.

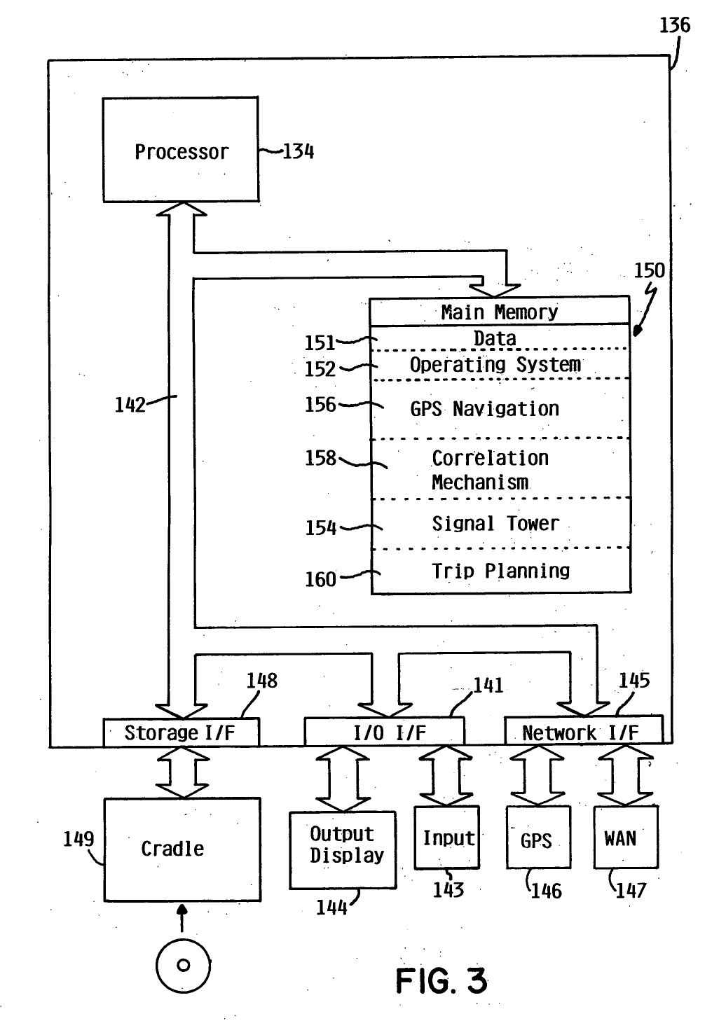

Referring to FIG. 3, the computer apparatus 136 includes at least one processor 134 coupled to a memory 150. The processor 134 may represent one or more processors (e.g., microprocessors). The memory 150 is adapted for storing data and applications that are consistent with use in implementing the present invention. The memory 150 may represent a suitable memory device comprising the main storage of the computer apparatus 136. The memory 150 may include any supplemental levels of memory, e.g., cache memories, non-volatile or backup memories (e.g., programmable or flash memories), read-only memories, etc. In addition, the memory 150 may be considered to include memory storage physically located elsewhere in the computer apparatus 136 e.g., any cache memory, as well as any storage capacity used as a virtual memory, e.g., as stored on the disk array or on another computer. The memory 150 can store the latitude/longitude information of the cellular phone towers throughout the state, country or entire world that are accessible by the wireless mobile device (via a web service provider). This information could be initially loaded by the service provider in the memory and then updated later via download from the internet or even download over the wireless mobile device network (via a special download mode that could be triggered by the user).

In FIG. 2, the architecture of the cellular phone device 122 further includes an input/output (I/O) bus 142 that is coupled to various I/O interfaces, collectively 141, and couples the input/output devices to the processor and the memory. One or more input devices, collectively 143, are included (e.g., keyboard, mouse, trackball, joystick, touchpad, and/or microphone among others). Interactions with a user are supported by the input device 143. In this embodiment, the input device 143 that the I/O bus 142 couples to is a wireless mobile device keypad 143. An output device 144 may include (e.g., a monitor, LCD display screen panel, LED's and/or a speaker among others). In this embodiment, the output device 144 is a display screen for a cellular phone device. For example, the information to be displayed may include geographical location information of the base stations or cell reception area, the cellular phone device itself, as well as directions toward one or more base stations or cell reception areas, which satisfy the signal strength criterion in any display formats that may be used. The present invention contemplates that the mobile wireless device may only include a display for rendering the information provided by a service provider.

A network interface 145 may interface with one or more Global Positioning Satellite/System (GPS) locators 146 that receive signals from a plurality of GPS satellites (not shown). Although the disclosed system according to an embodiment of the invention uses a GPS system for obtaining global positioning information regarding the wireless mobile device, the invention is not limited to only this kind of positioning mechanism. The location of a wireless mobile device or client can be provided by any other equivalent geo-positioning system, such as a Doppler radar, visual contact, triangulation, an inertial guidance system (IGS), or the like.

The network interface 145 may includes an interface 147, for a Signal Tower Map download, and a wireless network 147 interface that cooperates with a WAN, LAN, and/or the Internet among others. The Signal Tower Map interface 147 enables the signal tower information regarding geographical information, such as longitude and latitude and signal strengths in various map formats, for example, to be downloaded to the computer apparatus 136. The I/O bus 142 may further couple to a storage interface 148 that cooperate with a cradle 149 for the cellular phone. The cradle 149 itself may connect to a software downloading device, such as disk drive (not shown) or the like which is configured to receive recordable media, such as a floppy disk or the like. This arrangement allows software and updated information from a service provider to be downloaded to the cellular phone device. Alternatively, software may also be downloaded through the network interface 145. One embodiment is from one or more server computer system(s) 162 (FIG. 1) having a processor 164 that controls a database 166 administered by a service provider. The pricing of the processing costs for a request for services and/or information consistent with the teachings of the present invention including updates may be determined with respect to any variety of pricing criteria. Included in such criteria, for example, may be time-based criteria, request-type or class criteria, priority criteria, historical information, system user identification criteria, subscription criteria, and combinations thereof. These pricing criteria may be applied to define pricing schedules that a manager (not shown) may access to calculate a cost. In one preferred embodiment, one or more database(s) 166 stores the pricing criteria as defined in service contracts.

The computer apparatus 136 operates on data 151 under the control of an operating system 152 that is, preferably, stored locally in the main memory 150. The operating system 152 executes or otherwise relies upon various computer software applications, components, programs, objects, modules, data structures, etc. In one illustrated embodiment, the memory 150 stores data or information pertaining to the geographical location and strengths of the signal towers of one or more service providers in specified regions. The foregoing information about the signal towers or cell reception areas is obtained by the signal tower information mechanism 154 in the memory 150. This information may be downloaded in response to a request for such as will be described. As noted, this information may be updated.

Also included in the memory 150 are a GPS navigation logic mechanism 156 and a GPS location/signal strength correlation logic mechanism 158 under the control of the computer apparatus 136. The GPS navigation logic mechanism 156 may be a system that is operable for providing navigation logic to a wireless mobile device. In particular, the GPS navigation logic mechanism 156 will provide directional information to the one or more predefined base stations. The directional information may take any suitable format for enabling a user to get from one location to another. Accordingly, not only will the user know which geographic coverage area to go to, but be provided with the appropriate instructions based on the current position of the wireless mobile device. The GPS location/signal strength correlation logic mechanism 158 is adapted to correlate the signal strengths of the towers relative as determined by the information provided relative to their geographic location to a current location of the wireless mobile device. The correlation performed by the location/signal strength correlation logic mechanism 158 operates to determine locations of the closest cellular towers or cell reception area in accordance to their predefined and categorized signal strengths being available so that users may make or maintain calls. This information may be downloaded by a service provider for, for example, a subscription fee. As noted earlier, the fees may be calculated in a variety of suitable ways and be varied to cover a wide variety of services to provide such information. The trip planning mechanism 160 may, preferably, plan one or more trips based on the presence of active wireless mobile device towers or cell coverage areas 601a-n having predefined signal characteristics that are available in a geographic area from a point of origin (e.g., Rochester, Minn.) to a trip destination (e.g., Chicago, Ill.) to enable a user to make or maintain telephone calls. Accordingly, the trip planning algorithm enables a user to input information regarding a point of trip origin and trip destination. A path may be selected in accordance with suitable criterion, such as shortest path, or so-called best paths including shortest path to a selected cell reception area or the like. Each of the so-called best paths may be based on any variety of configured or configurable criterions. In this embodiment, the trip planning mechanism may include an algorithm that selects a path that may remain within a predefined range of preselected cell reception area. Accordingly, a user may select a path based on the information regarding updated cell reception area between a point of origin and a destination point. The point of origin may be a current location of the wireless mobile device.

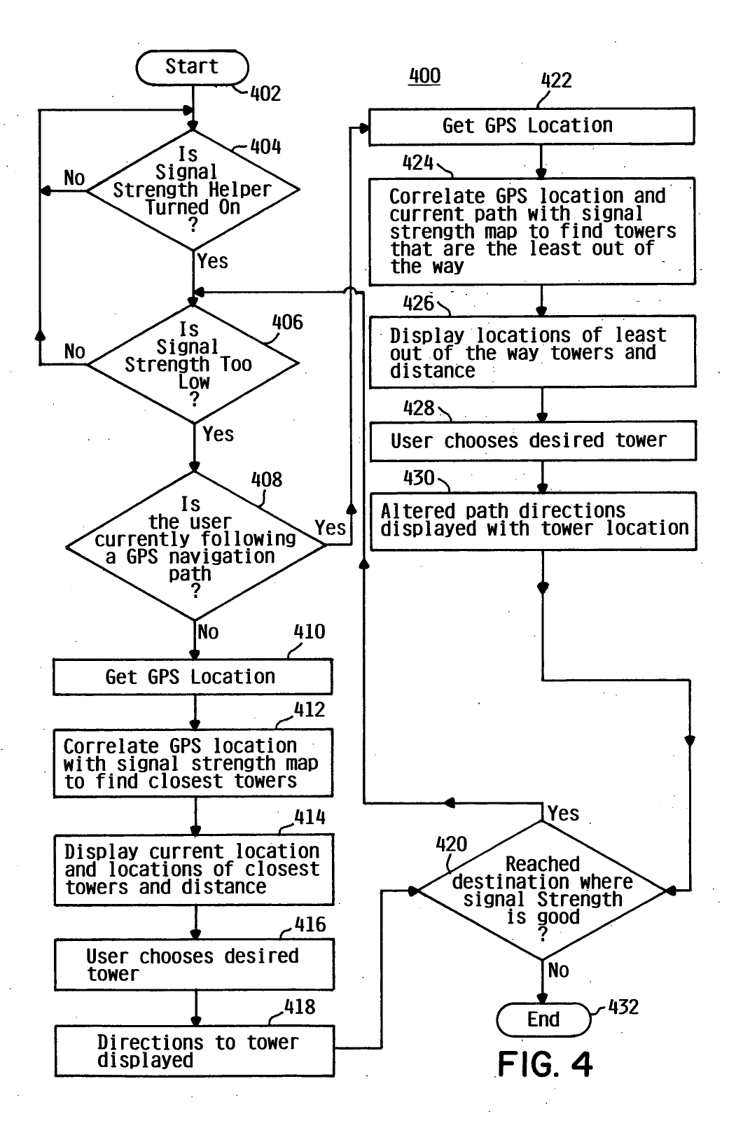

Reference is made to FIG. 4 for illustrating a process 400 that is an exemplary embodiment of the present invention. In a Start block 402, the process 400 commences, whereby a determination may first be made in an Is Signal Strength Helper On decision block 404. In particular, an algorithm determines whether the GPS locator 146 and the Signal Tower information mechanism 154 are activated as well as by a signal strength detector of the cellular phone device 122. If a negative (i.e., No) decision is made in the block 404, the process 400 returns to the Start block 402, whereby an appropriate signal representative of such condition alerts the user. Alternatively, if an affirmative (i.e., Yes) decision is made in the block 404, then the process 400 proceeds to an Is Signal Strength Too Low Decision block 406. In the Is Signal Strength Too Low Decision block 406 a determination is made by the mobile device unit 132 as to whether the strength of the signal of the wireless mobile device at its current location is strong enough to make or maintain calls. If a negative (i.e., No) decision is made, the process 400 returns to the Start block 402, and an appropriate signal representative of the too low condition may alert the user through the user interface display. Alternatively, if the decision in the block 406 is affirmative (i.e., Yes), then the determinations made by algorithms in Is the User Currently Following a GPS Navigation Path block 408 follow.

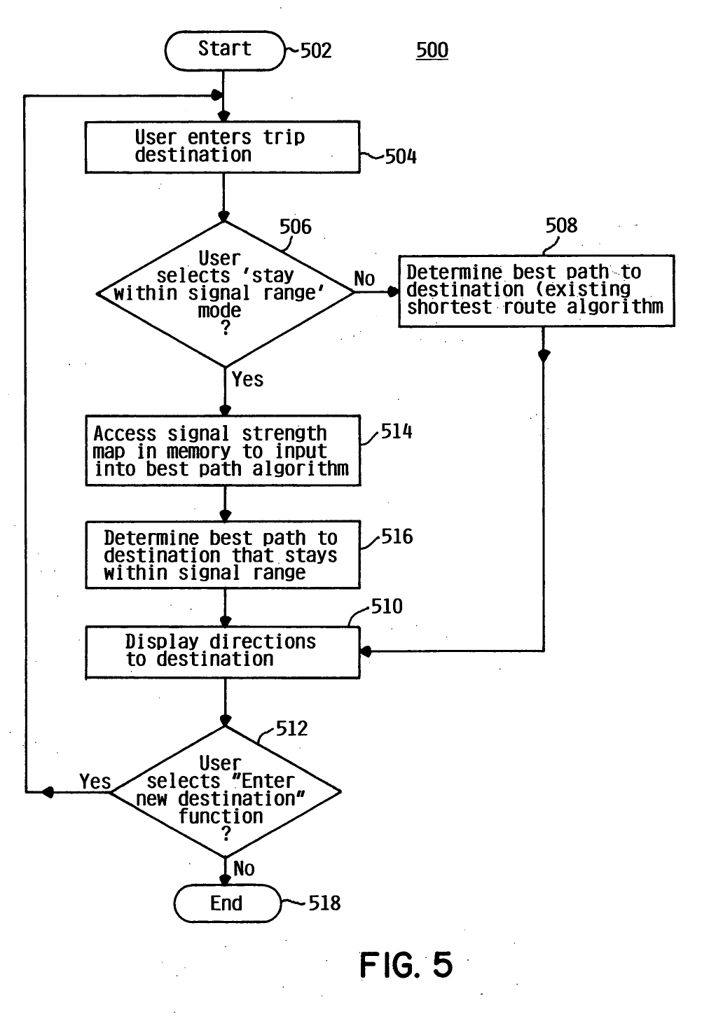

A determination is made in the Is the User Currently Following a GPS Navigation Path decision block 408, as to whether the user had previously selected to operate the process 400 in a GPS navigation path, whereby a predefined travel route was selected by the user. Selection of such a path may be performed by the method set forth in FIG. 5 described below or by other known planning algorithms in the trip planning mechanism 160. If a negative (i.e., No) decision is made in the block 408, the process 400 goes to gather the current GPS location of the cellular phone 122 by the GPS locator 146 in a Get current GPS Location block 410. The information obtained may include geographical information, such as longitude and latitude.

The process 400 then correlates the current GPS location of the cellular phone as noted above with the signal strength map of cellular towers or cell reception areas gathered from the signal tower information mechanism 154. These steps are performed by correlation algorithms in a Correlate GPS Location with Tower Signal Strength block 412. The correlation is performed by the location/signal strength correlation logic mechanism 158 operating to determine locations of the closest cellular towers or cell reception area in accordance to the predefined and categorized signal strengths being available so that users may make or maintain calls. Then the distances of the wireless mobile device unit to the nearest wireless mobile device towers are determined by the mechanism 158. Information in addition to distances may be provided that include fees and associated information pertaining to service costs for using each of the identified wireless mobile device towers or cell reception area that are categorized as noted above. The tower or cellular reception area signal strength information may be available from the memory 150. Alternatively, it may be obtained in real time from current downloading from the server computer 162 of a service provider. Alternative sources of the same or similar information may exist. For example, such information may be obtained by downloading from the Internet through a service provider rather than through preloading. Preferably, the closest wireless mobile device towers or cell reception area may be those of the user's service provider to avoid roaming.

Thereafter, the process 400 goes to a Display block 414 whereat the current location of the wireless mobile device is displayed along the locations of the closest towers or cell reception area having adequate or predefined signal characteristics. Such display is, preferably, in the format of a map (not shown) on the display. Thereafter, a User Select block 416 follows in which the user selects or chooses the desired cell reception area to travel. In this regard, the user may activate the keypad. Other suitable input devices may be used for selecting one or more of the closest wireless mobile device towers or cell reception area to make such a selection.

Following the foregoing, directions to the nearest identified wireless mobile device tower are obtained from the GPS navigation logic mechanism 156 in a Get Directions to Nearest Tower block 418. The direction information may be tied to a particular map that is used. However, a wide variety of formats (e.g., maps) for displaying information about the towers or cell reception area and signal strength are envisioned.

Following the block 418, the process 400 then proceeds to a Reached Destination Where Signal Strength is Good block 420. In the block 420, decisions are made as to whether or not good reception is actually present at the location of the tower or cell reception area previously selected. In this regard, the cell phone collects signal strength information in normal fashion from the wireless mobile device unit 132. If an affirmative, (i.e. Yes) decision is made, then the process 400 returns to an Is Signal Strength Too Low block 406, whereby continued processing in the manner described above follows. On the other hand, if the decision is No, then the process 400 ends in the End block 432.

Alternatively, if an affirmative (i.e., Yes) decision is made in the block 408 that the user is not currently following a GPS navigation path, then the process 400 goes to a Get GPS Location block 422, whereat the GPS location of the wireless mobile device is obtained by the GPS locator 146. Thereafter, the process 400 proceeds to a Correlate GPS and Current Path block 424 wherein algorithms correlate the current GPS location of the cellular phone with the signal strength map to determine the ranges of the closest wireless mobile device towers or cell reception area that have predefined signal characteristics. The predefined distance ranges include those towers or cell reception areas that are considered not too distant from a cellular phone. The user may configure what distances are considered too distant. These steps are performed by the correlate GPS location with signal strength mechanism 158. Accordingly, the nearest wireless mobile device towers or cell reception area to the wireless mobile device wherein the signal strengths are sufficient to make or maintain a call are listed or displayed.

Thereafter, in a Display Locations block 426, appropriate information, such as the locations of wireless mobile device towers or coverage areas within the predefined distances from the intended travel route may be displayed in a manner as noted above. Advantageously, users may plan trips according to their desire to maintain connectivity to the wireless mobile device network during the course of the journey.

Following the display in the Display Locations block 426, a user may appropriately select one or more of the locations in a User Chooses block 428, whereby the user may remain connected to the network. Thereafter, altered path directions are provided to the User in the Altered Path Directions block 430. This is performed by the GPS navigation logic mechanism 156 that provides the directions to the user in response to a user's selection in the block 428. Such information is rendered on the phone display. It will be appreciated that the altered directions are different from those give when the trip planning mechanism 160 was utilized. Advantageously, this provides considerable versatility for a user.

Thereafter, the process 400 goes to the Reached Destination Where Signal Strength is Good Block 420. In the block 420, determinations are made as to whether or not the signal strength of the wireless mobile device in the coverage area indicated by the directions of the block 428 is, indeed, strong enough to provide a good reception area. Should the determination in the block 420 be affirmative (i.e., Yes) that the wireless mobile device has not reached the destination, the process will loop back to the block 406 for continued processing. If the determination in the block 420 is negative (i.e., No) then the process 400 ends in the End block 432.

Reference is made to FIG. 5 for illustrating an exemplary embodiment of the trip planning process 500 which maybe implemented by the trip planning mechanism 160 of the present invention. The planning of a trip by the trip planning mechanism 160 is based on the presence of active wireless mobile device towers or cell coverage areas 601a-n (collectively 601) having predefined signal characteristics, such as signal strength and/or specific carrier, that are available in a geographic area from a point of origin (e.g., Rochester, Minn.) to a trip destination (e.g., Chicago, Ill.) to enable a user to make or maintain telephone calls. The point of origin may be a current location of the wireless mobile device. The trip planning mechanism 160 may reside locally in the memory or on a server 162 maintained by the service provider.

The trip planning process 500 commences in a Start block 502. Thereafter, the trip planning process 500 proceeds, whereby the user enters or inputs a trip designation in a User Enters Trip Destination block 504 through a user input device 143. In a User Selects ‘Stay’ within Signal Range Mode block 506, a decision is made as to whether the user had selected a mode to select a path that stays within the range of the signals of predefined signal characteristics that define the cell reception areas 601. If the decision is No, then a determine path to destination algorithm is selected in a Determine best path to Destination block 508. In this regard, the GPS navigation logic mechanism may determine the best path or route for following based on a suitable algorithm. For example, in this embodiment the so-called best path may include one of several preferred paths, such as the shortest path or route from the point of origin to the trip destination. It will be appreciated that many such suitable algorithms exist and may be applied by the trip planning mechanism 160. Thereafter, the process 500 proceeds to a Display Directions to Destination block 510 in which the directions may be displayed in the output display 144. Other paths may be selected using different suitable algorithms. Even algorithms yet developed are contemplated for use. From the block 510, the process then goes to the User Selects “Enter New Destination” function in the block 512. The operations of the block 512 are set forth below.

Alternatively, if the signal range mode is selected (i.e., Yes) in the User Selects ‘Stay’ within Signal Range Mode block 506, then access to information regarding cell reception area having predefined signal characteristics and their related geographical information may be gathered from the memory 150 by operation of the trip planning mechanism 160 in the Access Signal Strength Map in the Memory block 514. As noted, such information may be pre-loaded or presently downloaded from memory from a service provider server. Thereafter, in the Determine Best Path To Destination that Stays Within Signal Range block 516, the trip planning mechanism 160 operates for defining the best path or trip route from the point of origin to the trip destination that takes into account the predefined cell reception areas 601 having the predefined signal characteristics of interest to the user, generally signal strength for purposes of maintaining connectivity.

Following the block 516, the process 500 goes to the Display Directions to Destination block 510. In the block 510 the directions obtained in the block 516 may be displayed in the output display 144. After the block 510, the process 500 goes to a User Selects “Enter New Destination function” in a decision block 512 that is under control of the trip planning mechanism 160. As a result, the user is given another opportunity to choose different paths to different locations by allowing the user to Enter New destination. If the user's decision in the block 512 is negative (i.e., No) then the process 500 ends in an End block 518. Alternatively, if the user's decision is affirmative (i.e., Yes), then the process loops back to the Start block 502 for continued prosecution.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable signal bearing media used to actually carry out the distribution. Examples of computer readable signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

Although the present invention has been described in detail with reference to certain examples thereof, it may be also embodied in other specific forms without departing from the essential spirit or attributes thereof. For example, those skilled in the art will appreciate that the present invention is capable of being distributed as a program product in a variety of forms, and applies equally regardless of the particular type of signal bearing media used to actually carry out the distribution. Examples of suitable signal bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive, a CD-R disk, a CD-RW disk, or hard-disk drive); or (iii) information conveyed to a computer by a communications medium, such as through a computer or telephone network, including wireless communications, and specifically includes information downloaded from the Internet and other networks. Such signal-bearing media, when carrying computer-readable instructions that direct the functions of the present invention, represent embodiments of the present invention.

Embodiments of the present invention may also be delivered as part of a service engagement with a client company, nonprofit organization, government entity, internal organizational structure, or the like. Aspects of these embodiments may include configuring a computer system to perform, and deploying software systems and web services that implement, some or all of the methods described herein. Aspects of these embodiments may also include analyzing the client company, creating recommendations responsive to the analysis, generating software to implement portions of the recommendations, integrating the software into existing processes and infrastructure, metering use of the methods and systems described herein, allocating expenses to users, and billing users for their use of these methods and systems.

The embodiments and examples set forth herein were presented to best explain the present invention and its practical applications and to thereby enable those skilled in the art to make and use the invention. However, those skilled in the art will recognize that the foregoing description and examples have been presented for the purposes of illustration and example only. The description set forth is not intended to be exhaustive or to limit the invention to the precise forms disclosed. In describing the above preferred embodiments illustrated in the drawings, specific terminology has been used for the sake of clarity. However, the invention is not intended to be limited to the specific terms selected. It is to be understood that each specific term includes all technical equivalents that operate in a similar manner to accomplish similar purposes and yet to be developed equivalents. Many modifications and variations are possible in light of the above teachings without departing from the spirit and scope of the appended claims.

What is claimed is:

1. A computer-implemented method comprising:
determining the location of one or more cell reception areas having predefined signal characteristics relative to a current location of the wireless mobile device; and,
dynamically determining directions from the wireless mobile device at the current location to selected ones of the one or more cell reception areas having at least predefined signal characteristics.

2. The computer-implemented method of claim 1 further including providing the directions from the wireless mobile device at the current location to the one or more cell reception areas having predefined signal characteristics.

3. The computer-implemented method of claim 2 wherein the having predefined signal characteristics includes having predefined signal strengths.

4. The computer-implemented method of claim 1 further wherein the determining the current location includes utilizing a global position system.

5. The computer-implemented method of claim 3 wherein dynamically determining directions includes correlating the current location of the wireless mobile device to locations of cell reception area having predefined signal strengths.

6. The computer-implemented method of claim 5 wherein the dynamic determining determines if the cell reception areas are too far away from the wireless mobile device or a travel path.

7. The computer-implemented method of claim 1 further including providing a navigation logic mechanism that determines the directions.

8. The computer-implemented method of claim 1 wherein the dynamic determining is carried out within a wireless mobile client device that is accessible to a network.

9. The computer-implemented method of claim 1 wherein the dynamic determining is carried out within a server computer system accessible to a network.

10. The computer-implemented method of claim 2 wherein the determining the direction, the dynamic determining, and the providing the directions are carried out within a wireless mobile client device that is accessible to a network.

11. An apparatus comprising:
at least one processor;
a memory coupled to the at least one processor;
a correlating mechanism program residing in the memory and executed by at least the one processor, the mechanism correlating a current location of wireless mobile device and the locations of one or more cell reception areas; and, a navigation mechanism residing in memory and executed by at least the one processor for dynamically determining directions from the wireless mobile device to the one or more cell reception areas having the at least predefined signal characteristics.

12. The apparatus of claim 11 further including having the navigation mechanism providing the directions from the wireless mobile device at the current location to one or more of the cell reception areas having predefined signal characteristics.

13. The apparatus of claim 12 further including a global positioning device for determining the current location of the wireless mobile device.

14. The apparatus of claim 13 wherein the correlating mechanism correlates the GPS signals of the current location of the wireless mobile device and the locations of the one or more cell reception areas.

15. The apparatus of claim 13 wherein the correlating mechanism dynamically determines if the cell reception areas are too far away from the wireless mobile device or a travel path.

16. The apparatus of claim 11 further wherein the navigation mechanism determines the best route to selected ones of the cell reception areas.

17. A telecommunication system for informing a wireless mobile device of cell reception areas having predefined signal characteristics comprising:
a network having a plurality of cell reception areas;
a wireless mobile device in communication with a plurality of cell reception areas;
the wireless mobile device includes at least one processor; a memory coupled to the at least one processor; and, a correlating mechanism program residing in the memory and executed by the at least one processor, the mechanism determining the location of the one or more cell reception areas having predefined signal characteristics relative to the wireless mobile device at a current location; and, a navigation mechanism residing in memory and executed by at least the one processor for dynamically determining directions from the wireless mobile device to the one or more cell reception areas having the at least predefined signal characteristics.

18. The system of claim 17 further including the navigation mechanism providing directions from the wireless mobile device to at least one of the cell reception areas.

19. The system of claim 17 wherein the navigation mechanism renders a best path direction.

20. The system of claim 17 wherein the correlating mechanism correlates GPS signals representative of a current location of the wireless mobile device to locations of the one or more cell reception areas having predefined signal characteristics.

21. The system of claim 17 further wherein the correlating mechanism dynamically determines if the cell reception areas are too far away from the wireless mobile device or a travel path.

22. A computer program product comprising:
a correlating mechanism program for determining the location of one or more cell reception areas having predefined signal characteristics relative to a wireless mobile device at a current location; and a navigation mechanism for dynamically determining directions from the wireless mobile device to the one or more cell reception areas having the at least predefined signal characteristics; and,
signal bearing media bearing the correlating and navigation mechanisms.

23. The computer program product of claim 22 wherein the navigation mechanism renders the directions to the one or more cell reception area.

24. The computer program product of claim 22 wherein the correlating mechanism correlates GPS signals of the current location of the wireless mobile device to locations of the cell reception areas having predefined signal characteristics.

25. The computer program product of claim 23 wherein the navigation mechanism renders one or more paths of direction to the one or more cell reception area.

26. A computer-implemented method of providing a service for a fee in a telecommunication system that includes a plurality of cell reception areas that provide information to wireless mobile devices, the computer-implemented method comprising: deploying information by a service provider for a fee regarding predefined signal characteristics of cell reception areas and geographic locations of the cell reception areas to corresponding ones of wireless mobile devices, wherein the deployed information is geographically related to a current location of a wireless mobile device requesting such information so that a correlating mechanism program residing in a memory determines the location of one or more cell reception areas having predefined signal characteristics relative to the wireless mobile device at its current location; and, then dynamically determining directions from the wireless mobile device to the one or more cell reception areas having the at least predefined signal characteristics.

27. The computer-implemented method of claim 26 wherein the mechanism program resides in a memory of the requesting mobile wireless device.

28. The computer-implemented method of claim 26 wherein the mechanism program residing in a memory is carried out by server computer system accessible to a network.

29. The computer-implemented method of claim 26 wherein the current location of the wireless device is gathered by a global positioning system residing in the requesting mobile wireless device.

30. The computer-implemented method of claim 26 wherein the deployed information for a fee is rendered based on a subscription service by the service provider.

31. A computer-implemented method of determining one or more travel routes in accordance with cell reception areas having predefined signal characteristics, the method comprising: inputting data including an origination location and a trip destination, determining if a mode is selected to stay within a predefined range of the predefined signal characteristics while traveling, accessing signal strength data of cell reception areas to input into a travel planning algorithm for planning a route to the trip destination, if the mode is selected; and, determining a travel route to the trip destination that stays within the predefined range of cell reception areas having predefined signal characteristics.

32. The computer-implemented method of claim 31 further comprising providing information that includes a best path travel route to the trip destination that remains within the predefined range.

33. The computer-implemented method of claim 31 further comprising providing information about a travel route that need not be entirely within the range.

34. A computer-implemented method of providing a service for a fee for planning a trip route from an origination location to a trip destination for a user of a wireless mobile device using a network having a plurality of cell reception areas, the method comprising: providing a service for a fee of selecting a travel route to the trip destination from the origination location that remains in a predefined range of cell reception areas of the predefined signal characteristics.

35. An apparatus for determining one or more travel routes in accordance with signal strengths of wireless cell reception areas, the apparatus comprising:
at least one processor;
a memory coupled to the at least one processor; and,
a trip planning mechanism program residing in the memory and executed by the at least one processor, the mechanism is enabled to obtain information including an origination location and a trip destination, if a mode is selected for determining a travel route to stay within a predefined range of cell reception areas having predefined signal characteristics, then accessing signal strength and geographic location information of cell reception areas for mobile wireless devices to input into a travel planning algorithm; and, determining at least a travel route to the trip destination that remains within the predefined range of the cell reception areas having predefined signal characteristics.

36. The apparatus of claim 35 further including having the trip planning mechanism-providing information including a best path travel route that remains within the range.

37. A computer-implemented method of providing a service for a fee in a telecommunication system for planning a trip route for a user of a wireless mobile device, wherein the system includes a network having a plurality of cell reception areas; the computer-implemented method comprising: deploying information by a service provider to a user of a wireless mobile device for a fee regarding signal strengths and geographic location of cell reception areas in a geographic area that includes a trip originating location and a trip destination; and, selecting a travel route to the trip destination from the originating location that remains in a predefined range of cell reception areas of the predefined signal characteristics.

38. The computer-implemented method of claim 37 further comprising providing information including a path of travel route to the trip destination that remains within the predefined range.

39. The computer-implemented method of claim 37 wherein the deployed information for a fee is rendered based on a subscription service by the service provider.

40. The computer-implemented method of claim 37 wherein the deploying and selecting are carried out within a server computer system that is accessible to the network.

41. The computer-implemented method of claim 40 wherein the providing information is carried out in a wireless mobile client device that is accessible to the network.
